(19) United States
(12) Patent Application Publication
(10) Pub. No.: US 2008/0158595 A1
(43) Pub. Date: Jul. 3, 2008

(54) PRINTING SYSTEM AND CONTROL METHOD THEREOF

(75) Inventor: Jung Hyuck IM, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/965,195

(22) Filed: Dec. 27, 2007

(30) Foreign Application Priority Data
Dec. 28, 2006 (KR) 2006-136539
Nov. 23, 2007 (KR) 2007-120015

(51) Int. Cl. G06F 3/12; G06F 15/00; G06K 15/00

(52) U.S. Cl. 358/1.15; 358/1.13

(57) ABSTRACT

Disclosed are a printing system and a control method thereof. The system is capable of effectively performing printing and reducing a printing time. The method includes determining a division number of a document to be printed when a printing command is input, dividing the document according to the division number, converting data representing divided documents into print data by using selected terminal devices, and performing a printing operation by transferring the print data from the selected terminal devices to an image forming apparatus.

### CROSS-REFERENCE TO RELATED APPLICATION

This application claims the benefit of Korean Patent Application Nos. 2006-136539, filed on Dec. 28, 2006, and 2007-120015, filed on Nov. 23, 2007 in the Korean Intellectual Property Office, the disclosure of which is incorporated herein by reference.

### BACKGROUND OF THE INVENTION

1. Field of the Invention

Aspects of the present invention relate generally to a printing system and a control method thereof, and more particularly to a printing system capable of dividing a document to be printed and converting data of the divided documents into print data by using a plurality of terminal devices connected through a network to perform printing work and a control method thereof.

2. Description of the Prior Art

Printers can be classified according to various classification standards. For instance, printers can be classified into a printer description language (PDL) printer (or a PCL printer) and a graphics device interface (GDI) printer according to the conversion scheme of print data.

The PDL printer refers to a printer, which has a printer driver to receive print data, convert the print data into a PCL format, and then convert the print data into bit map data to perform a printing operation. The GDI printer refers to a printer, which receives print data converted into bit map data in a printer driver to output the print data.

In the GDI printer, most functions performed during a printing operation, excluding physical printing, are performed by the printer driver of a host computer. As a result, it is possible to minimize the need for a printer controller and additional memory. Thus, the manufacturing cost for the printer can be reduced.

However, since the process of forming a printing image must be performed using the printer driver of the host computer, the GDI printer may lengthen the printing time when there is a great amount of print data to be printed. Such a problem may also occur in a printing system in which the GDI printer is connected to a plurality of host computers through a network.

### SUMMARY OF THE INVENTION

Accordingly, aspects of the present invention provide a printing system capable of converting data of a document into print data by using a plurality of terminal devices connected through a network and a control method thereof.

According to an example embodiment of the present invention, a method of controlling a printing system including a plurality of terminal devices connected to an image forming apparatus, via a network, the method including determining a division number of a document to be printed when a printing command is input, dividing the document according to the division number, converting data representing the divided documents into print data by using selected terminal devices, and performing a printing operation by transferring the print data from the selected terminal devices to the image forming apparatus.

According to an aspect of the present invention, the division number is determined by a terminal device which receives the input printing command, and divides the document to send a portion of the data representing the divided documents to other terminal devices among the plurality of terminal devices.

According to an aspect of the present invention, the division number is determined according to a number of the terminal devices having a printer driver identical to a printer driver of the terminal device which receives the printing command.

According to an aspect of the present invention, the image forming apparatus searches the plurality of terminal devices for terminal devices having a printer driver identical to a printer driver of a terminal device which receives the printing command and provides the terminal device which receives the printing command with a search result.

According to an aspect of the present invention, the method further comprises an operation of arranging the print data according to a predetermined order using the image forming apparatus.

According to an aspect of the present invention, the division number is determined by a server, and the server divides the document to send the data of the divided documents to the plurality of terminal devices.

According to an aspect of the present invention, the server searches the terminal devices for terminal devices having a printer driver identical to a printer driver of the terminal device which receives a printing command and provides the terminal device which receives the printing command with a search result.

According to an aspect of the present invention, the method further includes arranging the print data according to a predetermined order using a server,

According to another example embodiment of the present invention, a printing system includes a first terminal device to convert data representing some divided documents into print data, N terminal devices to receive data representing remaining divided documents excluding the data representing some divided documents from the first terminal device and to convert the data representing remaining divided documents into remaining print data, wherein N is a natural number, and an image forming apparatus to print out the print data and the remaining print data received from the first and N terminal devices.

According to an aspect of the present invention, the first terminal device includes a printer driver to divide a document to be printed into the divided documents and a controller to transmit the data representing remaining divided documents to the N terminal devices.

According to an aspect of the present invention, the image forming apparatus comprises a controller to search for terminal devices among the N terminal devices having a printer driver identical to a printer driver of the first terminal device and to provide the first terminal device with a search result and a storage module to store information about the printer drivers of the first and N terminal devices, wherein the controller searches the information.

According to still another example embodiment of the present invention, a printing system includes a server to divide a document to be printed and to send data of divided documents to a plurality of terminal devices when a printing command is input, and to receive print data converted by the plurality of terminal devices based on the divided documents, and an image forming apparatus to print out the print data received from the server.

According to another aspect of the present invention, the server includes a storage module to store information related to drivers of the terminal devices, and a controller to search the terminal devices for terminal devices using a driver identical to a driver of one of the terminal devices which receives the printing command when the printing command is input.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram of a printing system according to a first example embodiment of the present invention;

FIG. 2 is a flowchart of a printing procedure according to a first example embodiment of the present invention;

FIG. 3 is a block diagram of a printing system according to a second example embodiment of the present invention; and

FIG. 4 is a flowchart of a printing procedure according to a second example embodiment of the present invention.

### DETAILED DESCRIPTION OF THE PREFERRED EMBODIMENTS

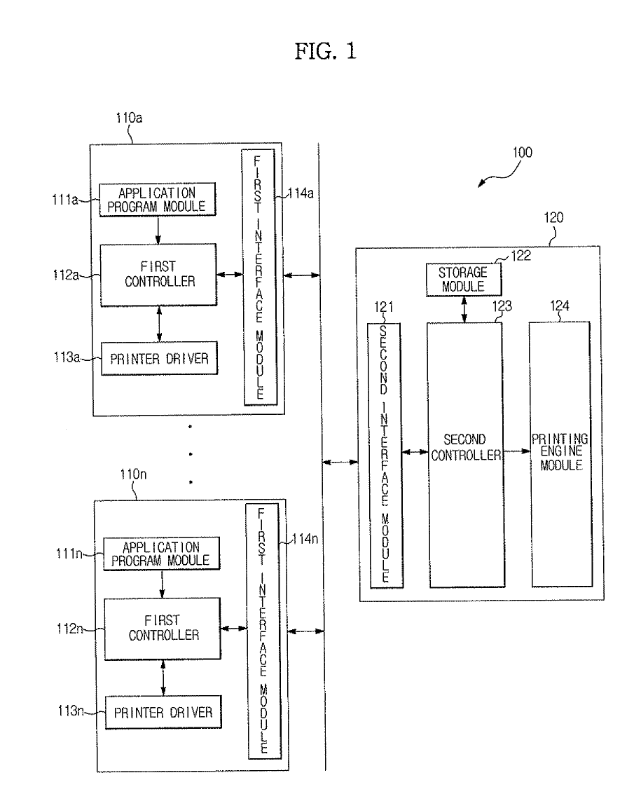

Reference will now be made in detail to the present embodiments of the present invention, examples of which are illustrated in the accompanying drawings, wherein like reference numerals refer to the like elements throughout. The embodiments are described below in order to explain the present invention by referring to the figures. FIG. 1 is a block diagram showing a printing system according to a first example embodiment of the present invention. As shown in FIG. 1, the printing system 100 includes terminal devices 110a to 110n and an image forming apparatus 120. The terminal devices 110a to 110n include application program modules 111a to 111n, first controllers 112a to 112n and printer drivers 113a to 113n, respectively. The image forming apparatus 120 includes a second interface module 121, a storage module 122, a second controller 123 and a printing engine module 124.

A user can prepare documents, read prepared documents and input a printing command by using the application program modules 111a to 111n of the terminal devices 110a to 110n. These terminal devices 110a-110n may be embodied as various types of electronic appliances, such as a personal computer (PC), a notebook computer, and a personal digital assistant (PDA). In the embodiment where the terminal device 110 is a PC, various word programs may serve as the application program modules 111a to 111n.

The first controllers 112a to 112n control the operation of the terminal devices 110a to 110n and transmit some of the documents, which are divided by the printer drivers 113a to 113n, to other terminal devices. Upon receiving the printing command for the document prepared by the user, the printer driver 113a installed at the first terminal device 110a divides the document to be printed into a plurality of documents. The division number of the document is determined based on the number of the terminal devices 110a to 110n connected through the network in relation to the printing command. That is, the division number of the document is determined based on the number of the terminal devices 110a to 110n using the same printer driver and capable of converting data of the document into print data. For instance, if the printing system 100 includes a first terminal device 110a and three other terminal devices 110b, 110c and 110n using the same driver as that of the first terminal device 110a, the document is divided into four documents.

In addition, the printer driver 113a converts data of the divided documents into print data through a rendering scheme. Furthermore, the printer driver 113a provides the terminal devices with the documents in a different ratio according to performance of the terminal devices. For instance, if the performance ratio between the first and second terminal devices 110a and 110b is 3:2, the printer driver 113a divides the document in a ratio of 3:2 and provides the first terminal device 110a with some documents (3/5 documents) and the second terminal device 110b with the remaining documents (2/5 documents) according to the ratio.

The first interface modules 114a to 114n are provided to enable data communication between the terminal devices 110a to 110n and the image forming apparatus 120. Meanwhile, the second interface module 121 of the image forming apparatus 120 enables data communication with the terminal devices 110a to 110n and receives print data from the terminal devices 110a to 110n. The storage module 122 stores information about the printer drivers 113a to 113n of the respective terminal devices 110a to 110n.

In the case of the GDI driver, most of the printing functions performed during a printing operation, excluding physical printing, may be accomplished by the GDI driver, Programs used by the GDI driver to perform printing operations includes PCL4 (printer command language) of HP (Hewlett-Packard), PostScript of ADOBE, and GDI (Graphics Device Interface). It is understood that other programs may also be used by the GDI driver to perform printing operations.

When a divisional printing command for the document is transmitted from at least one of the terminal devices 110a to 110n which receives the printing command, the second controller 123 installed at the image forming apparatus 120 searches other terminal devices among the terminal devices 110a to 110n capable of converting data of the document into print data and transmits the search result to the at least one of the terminal devices 110a to 110n which received the printing command.

In detail, the second controller 123 installed at the image forming apparatus 120 searches N terminal devices 110b to 110n (wherein N is a natural number greater than 1) that use the same driver as the driver used by the first terminal device 110a based on information stored in the storage module 122. Then, the second controller 123 transmits the search result, that is, identification information (for instance, IP (internet protocol) address information) of the N terminal devices 110b to 110n to the first terminal device 110a.

In addition, the second controller 123 arranges the print data received from the terminal devices 110a to 110n according to a predetermined order, thereby integrating the print data as a single document. That is, the second controller 123 installed at the image forming apparatus 120 arranges the print data received from the terminal devices 110a to 110n according to the sequence of pages of the documents and integrates the arranged print data as one document. Then, the second controller 123 transmits the document (arranged print data) to the printing engine module 224. In order to arrange the print data according to the sequence of pages, the second controller 123 utilizes the sequence of pages stored in a header of the print data. Thus, since the image data can be arranged according to the sequence of pages, the printing operation can be easily accomplished without performing collecting and additional functions to arrange the print data.

The printing engine module 124 prints the arranged image data on a printing medium, such as a sheet of paper, a transparency sheet, stationary, etc. The printing engine module 124 refers to a mechanical unit that actually prints out the print data on the printing medium. In the case of a laser printer, the printing engine module 124 includes a photosensitive drum, an LSU (laser scanning unit), a transfer unit, a developing unit, a printing medium feeding unit, a printing medium discharge unit, etc.

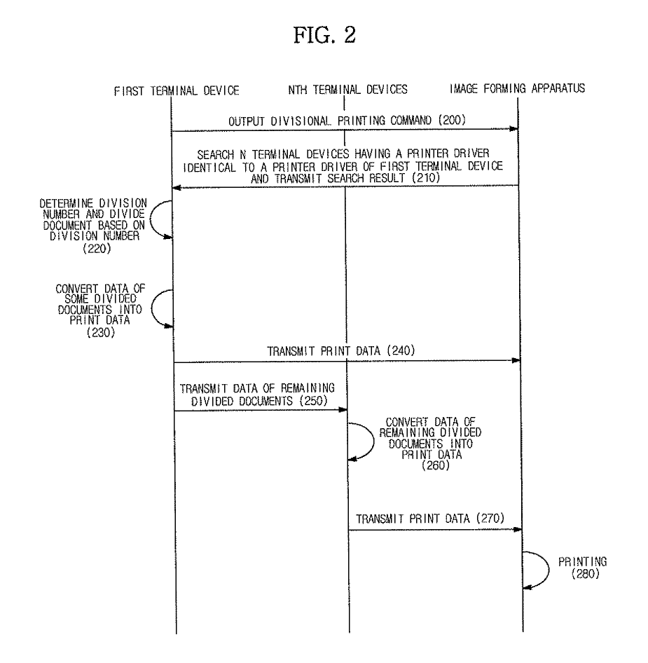

Turning now to FIG. 2, the printing process according to the first example embodiment of the present invention is illustrated. Referring to FIG. 2, as the divisional printing command is output to the image forming apparatus 120 at operation 200, the image forming apparatus 120 searches the N terminal devices 110b to 110n for terminal devices that use the same printer drivers as the printer driver used by the first terminal device 110a, and then transmits the search result to the first terminal device 110a at operation 210.

Then, the first terminal device 110a determines the division number of the document based on the search result received from the image forming apparatus 120, and divides the document according to the determined division number at operation 220. At this time, data of some documents are converted into print data at operation 230). This print data is then transmitted to the image forming apparatus 120 at operation 240.

Meanwhile, the first terminal device 110a transmits data of the remaining documents to the remaining N terminal devices 110b to 110n at operation 250. For instance, when a first terminal device 110a and a second terminal device 110b are provided with the same printer driver, if the document to be printed has a total of 28 pages, the document is divided into two documents having 14 pages, respectively, in such a manner that data of 14 pages can be transmitted to the first terminal device 110a and data of remaining 14 pages can be transmitted to the second terminal device 110b.

In addition, upon receiving the data of the remaining document, the terminal devices among the N terminal devices 110b to 110n which are provided with the same printer driver as the first terminal device 110a convert the remaining data into print data at operation 260 and send the remaining print data to the image forming apparatus 120 at operation 270.

Thus, the image forming apparatus 120 receives the print data from the first terminal device 110a and the terminal devices among the N terminal devices 110b to 110n which are provided with the same printer driver, and prints out the print data at operation 280.

When printing the print data in the image forming apparatus 120, the print data is arranged according to the sequence of pages of the document such that the print data can be printed according to the sequence of pages of the document.

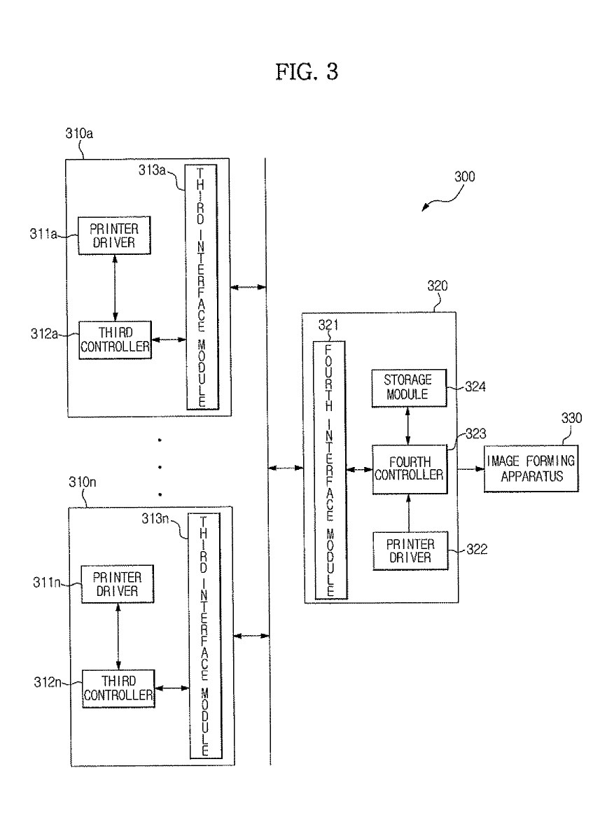

Hereinafter, a printing system 300 according to a second example embodiment of the present invention will be described. FIG. 3 is a block diagram of the printing system 300 according to the second example embodiment of the present invention. The printing system 300 includes terminal devices 310a to 310n, a server 320 and the image forming apparatus 120.

In the following description, the function and structure of components which are the same as those components already described above in connection with the first example embodiment will be omitted in order to avoid redundancy. The terminal devices 310a to 310n include printer drivers 311a to 311n, third controllers 312a to 312n and third interface modules 313a to 313n, respectively. The printer drivers 311a to 311n receive data of documents to be printed and convert the data into print data.

The third controllers 312a to 312n transmit the print data to the server 320. The third interface modules 313a to 313n are used to enable data communication between the terminal devices 310a to 310n and the server 320. The server 320 includes a fourth interface module 321, a printer driver 322, a fourth controller 323 and a storage module 324.

The fourth interface module 321 enables data communication between the terminal devices 310a to 310n and the image forming apparatus 330. The printer driver 322 divides the document into a plurality of documents as the document data is received from one terminal device 310a.

The fourth controller 323 controls the operation of the server 320. When a divisional printing command for the document is input from one terminal device 310a, the fourth controller 323 searches other terminal devices 310b to 310n capable of converting data of the document into print data. In addition, upon receiving the print data from the terminal devices 310a and 310n, the fourth controller 323 arranges the print data according to a predetermined order and then sends the print data to the image forming apparatus 330.

The storage module 324 stores information about the printer drivers 311a to 311n of the terminal devices 310a to 310n. The image forming apparatus 330 prints out the print data on a printing medium, such as a sheet of paper, a transparency sheet, stationary, etc. That is, the image forming apparatus 330 refers to a mechanical unit that actually prints out the print data on the printing medium.

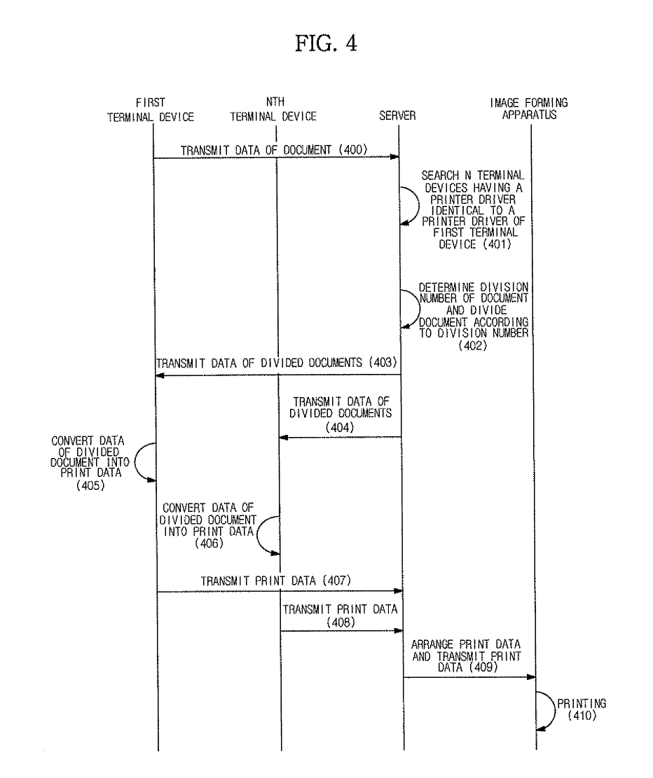

Hereinafter, the printing process according to the second example embodiment of the present invention will be described. FIG. 4 is a flowchart showing the printing process according to the second example embodiment of the present invention.

Referring to FIG. 4, the first terminal device 310a sends the data of the document to be printed to the server 320 at operation 400. The server 320 searches among the terminal devices 310b to 310n for terminal devices which use the same driver as the driver used by the first terminal device at operation 401.

Then, the division number of the document is determined based on the search result and the document is divided according to the determined division number at operation 402. Some of the data of the divided documents is sent to the first terminal device at operation 403, and other of the data of the divided documents is sent to the terminal devices which use the same printer driver as the driver used by the first terminal device 310a at operation 404.

Upon receiving the data of the divided documents, the first terminal device 310a and other terminal devices which use the same printer driver as the printer driver used by the first terminal device 310a convert the data into the print data at operations 405 and 406, respectively, and transmit the print data to the server 320 at operation 407 and 408, respectively.

As the print data is transmitted to the server 320 from the first terminal device 310a and other terminal devices which use the same printer driver as the printer driver used by the first terminal device 310a, the server arranges the print data according to a predetermined order and then sends the print data to the image forming apparatus 330 at operation 409. Upon receiving the print data from the server 320, the image forming apparatus 330 prints out the print data at operation 410.

As described above, according to aspects of the printing system and a control method thereof the print data are divided and converted through the terminal devices, such as the terminal devices 110a to 110n (FIG. 1) or 310a to 310n (FIG. 3) connected through the network to perform printing work, so that it is possible to effectively perform printing and to reduce a data conversion time and a printing time.

In addition, the print data are arranged according to the sequence of pages of the document in the printing system and the print data are printed according to the sequence of the pages, so that the printing matters can be easily obtained without performing an additional collecting operation or an additional arrangement operation.

While there have been illustrated and described what are considered to be example embodiments of the present invention, it will be understood by those skilled in the art and as technology develops that various changes and modifications may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the print data can be divided in accordance with an algorithm that allocates different data units to different terminals based on different types of conditions, such as, for example, availability, frequency of use and capacity Furthermore, separate transmissions, such as the transmission of the data of the divided documents at operations 403 and 404 (FIG. 4), may occur simultaneously as part of the same transmission. Accordingly, it is intended, therefore, that the present invention not be limited to the various example embodiments disclosed, but that the present invention includes all embodiments falling within the scope of the appended claims.

What is claimed is:

1. A method of controlling a printing system including a plurality of terminal devices connected to an image forming apparatus, via a network, the method comprising:
determining a division number of a document to be printed when a printing command is input;
dividing the document according to the division number;
converting data representing divided documents into print data by using selected terminal devices; and
performing a printing operation by transferring the print data from the selected terminal devices to the image forming apparatus.

2. The method as claimed in claim 1, wherein the division number is determined by a terminal device which receives the input printing command and divides the document and sends data representing the divided documents to the selected terminal devices among the plurality of terminal devices.

3. The method as claimed in claim 1, wherein one of the terminal devices receives the printing command, and the division number is determined according to a number of the terminal devices having a printer driver identical to a printer driver of the terminal device which receives the printing command.

4. The method as claimed in claim 1, wherein the image forming apparatus searches the plurality of terminal devices for terminal devices having a printer driver identical to a printer driver of a terminal device which receives the printing command and provides the terminal device which receives the printing command with a search result.

5. The method as claimed in claim 1, further comprising arranging the print data according to a predetermined order using the image forming apparatus.

6. The method as claimed in claim 1, wherein the division number is determined by a server, and wherein the server divides the document to send the data representing divided documents to the selected terminal devices.

7. The method as claimed in claim 6, wherein the server searches the terminal devices for terminal devices having a printer driver identical to a printer driver of the terminal device which receives the printing command and provides the terminal device which receives the printing command with a search result.

8. The method as claimed in claim 17 further comprising arranging the print data according to a predetermined order using a server.

9. A printing system comprising:
a first terminal device to convert data representing some divided documents into print data;
N terminal devices to receive data representing remaining divided documents excluding the data representing some divided documents from the first terminal device and to convert the data representing remaining divided documents into remaining print data, wherein N is a natural number; and
an image forming apparatus to print out the print data and the remaining print data received from the first and N terminal devices.

10. The printing system as claimed in claim 9, wherein the first terminal device comprises:
a printer driver to divide a document to be printed into the divided documents; and
a controller to transmit the data representing remaining divided documents to the N terminal devices.

11. The printing system as claimed in claim 9, wherein the image forming apparatus comprises:
a controller to search for terminal devices among the N terminal devices having a printer driver identical to a printer driver of the first terminal device and to provide the first terminal device with a search result; and
a storage module to store information about the printer drivers of the first and N terminal devices.

12. A printing system comprising:
a server to divide a document to be printed and to send data representing divided documents to a plurality of terminal devices when a printing command is input, and to receive print data converted by the plurality of terminal devices and based on the divided documents; and
an image forming apparatus to print out the print data received from the server.

13. The printing system as claimed in claim 12, wherein the server comprises:
a storage module to store information related to drivers of the terminal devices; and
a controller to search the terminal devices for terminal devices using a driver identical to a driver of one of the terminal devices which receives the printing command when the printing command is input.

14. The printing system of claim 9, wherein the first terminal device equally transmits the remaining portion of the data representing divided documents to the N terminal devices.

15. The printing system of claim 9, wherein the image forming apparatus arranges the data according to a sequence of pages of a document.
